(19) United States
(12) Patent Application Publication
(10) Pub. No.: US 2024/0320760 A1
(43) Pub. Date: Sep. 26, 2024

(54) PROMOTING COMPETITION BETWEEN USERS OF A SOCIAL NETWORK

(71) Applicant: Paul Jerome Humphries, III, Hamilton, OH (US)

(72) Inventor: Paul Jerome Humphries, III, Hamilton, OH (US)

(21) Appl. No.: 18/609,366

(22) Filed: Mar. 19, 2024

Related U.S. Application Data
(60) Provisional application No. 63/491,963, filed on Mar. 24, 2023.

(51) Int. Cl. G06Q 50/00; G06Q 10/0631

(52) U.S. Cl. CPC G06Q 50/01; G06Q 10/063112

(57) ABSTRACT

Systems, methods, and computer program products for processing requests from a user system associated with a user profile in a database of a social network website. The process includes receiving a challenge that identifies a plurality of users and a task or activity which one user is challenging another user to perform. The challenge is forwarded to the person being challenged, and in response to receiving an acceptance of the challenge from the second user, the challenge is published on the social network website.

### CROSS-REFERENCE TO RELATED APPLICATIONS

The present application claims the filing benefit of co-pending U.S. Provisional Application Ser. No. 63/491,963, filed Mar. 24, 2023, the disclosure of which is incorporated by reference in its entirety.

### BACKGROUND

Competition has been a core component of human existence for as long as there have been humans. Early forms of competition were for survival itself, and included competition over food, water, land, and other resources. Thankfully, as humans have matured as a species and developed technologies that enable us to control our environment, the need to directly compete with one another over the basic necessities of life has diminished. However, our basic need to compete with each other remains. Accordingly, many forms of competition have been developed to satisfy our inherent need to compete. These forms of competition include leisure activities such as sports and games, as well as political and economic systems that foster competition, such as democracy and capitalism.

Leisure-based forms of competition may be engaged in for enjoyment, to improve physical and mental skills, or to identify those who have extraordinary talent. The desire to compete, as well as watch others compete, has been a driving force behind the creation of multi-billion dollar industries, such as professional sports leagues, television networks, and the gaming industry. Existing technologies for interactive competition between individuals include video games and other forms of electronic entertainment. However, these forms of competition are limited by both the rules and the environment in which competition occurs, which is defined by someone other than the competitors. Thus, existing technologies aimed at fulfilling the desire to compete fail to provide individuals with a way of identifying potential opponents and engaging in direct competition with others on their own terms.

Thus, there is a need for improved systems, methods, and computer program products that provides individuals a way to identify and challenge opponents for competitions, and that determines who has won the resulting competitions.

### SUMMARY

In one aspect of the disclosure, a method of processing requests from a user system associated with a user profile in a database of a social network website is disclosed. The method includes receiving a challenge that identifies a first user, a second user, and a task or activity which the first user is challenging the second user to perform. The method further includes forwarding the challenge to the second user, and in response to receiving an acceptance of the challenge from the second user, publishing the challenge on the social network website.

In an embodiment of the method, the method may further include searching the database for the user profile of the second user, validating the challenge based at least in part on information in the user profile of the second user, and only forwarding the challenge to the second user if the challenge is valid.

In another embodiment of the method, validating the challenge may include comparing skill levels of the first user and the second user, and only validating the challenge if the skill levels match.

In another embodiment of the method, publishing the challenge may include posting information regarding the challenge on a home page of one or more users having profiles in the database, the challenge may identify at least one of a time, a date, and a location for performing the task or activity, and the location may be one of a geographic location or a virtual location.

In another embodiment of the method, the location may be the virtual location, and the method may further include defining a webpage on the social network website which provides the virtual location for performing the task or activity, and transmitting a link to the webpage to the user system of each of the first user and the second user.

In another embodiment of the method, the method may further include posting the challenge to a webpage of the social network website, and in response to a web browser visiting the webpage, displaying the challenge on a user interface of the web browser.

In another embodiment of the method, each user profile may define at least one of a category, a subcategory, and a group associated with the user profile.

In another embodiment of the method, each user profile may include a call-out record, and the method may further include adding the challenge to the call out record of the user profile of each of the first user and the second user in response to the second user accepting the challenge.

In another embodiment of the method, the method may further include posting a result of the challenge on the user profile of each of the first user and the second user in response to the challenge being completed.

In another embodiment of the method, the first user and the second user may be part of a plurality of users, and the method may further include receiving one or more votes from the plurality of users regarding each voting user's selection of a winner of the challenge, and selecting the winner of the challenge based at least in part on the one or more votes received.

In another embodiment of the method, a user may be required to be a member of a group with which the challenge is associated in order to vote on the winner of the challenge.

In another aspect of the disclosure, an apparatus for processing requests from the user system associated with the user profile in the database of the social network website is disclosed. The apparatus includes one or more processors and a memory. The memory is coupled to the one or more processors and includes program code that, when executed by the one or more processors, causes the apparatus to receive the challenge that identifies the first user, the second user, and the task or activity which the first user is challenging the second user to perform, forward the challenge to the second user, and in response to receiving the acceptance of the challenge from the second user, publish the challenge on the social network website.

In an embodiment of the apparatus, the program code may further cause the apparatus to search the database for the user profile of the second user, validate the challenge based at least in part on the information in the user profile of the second user, and only forward the challenge to the second user if the challenge is valid.

In another embodiment of the apparatus, the challenge may further identify the virtual location for performing the task or activity, and the program code may further cause the apparatus to define the webpage on the social network website which provides the virtual location for performing the task or activity, and transmit the link to the webpage to the user system of each of the first user and the second user.

In another embodiment of the apparatus, the program code may further cause the apparatus to post the challenge to the webpage of the social network website, and in response to the web browser visiting the webpage, display the challenge on the user interface of the web browser.

In another embodiment of the apparatus, each user profile may include the call-out record, and the program code may further cause the apparatus to add the challenge to the call out record of the user profile of each of the first user and the second user in response to the second user accepting the challenge, and post a result of the challenge on the user profile of each of the first user and the second user in response to the challenge being completed.

In another embodiment of the apparatus, the first user and the second user may be part of the plurality of users, and the program code may further cause the apparatus to receive one or more votes from the plurality of users regarding each voting user's selection of the winner of the challenge, and select the winner of the challenge based at least in part on the one or more votes received.

In another embodiment of the apparatus, the user may be required to be a member of the group with which the competition is associated in order to vote on the winner of the competition.

In another embodiment of the apparatus, the first user and the second user may be part of the plurality of users, and the program code may further cause the apparatus to maintain the record for each user including one or more of challenges won, challenges lost, challenges that were a draw, and challenges declined.

In another aspect of the disclosure, a computer program product for processing requests from the user system associated with the user profile in the database of the social network website is disclosed. The computer program product includes a non-transitory computer-readable storage medium, and program code stored on the non-transitory computer-readable storage medium. When executed by one or more processors, the program code causes the one or more processors to receive the challenge that identifies the first user, the second user, and the task or activity which the first user is challenging the second user to perform. The program code further causes the one or more processors to forward the challenge to the second user, and in response to receiving the acceptance of the challenge from the second user, publish the challenge on the social network website.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a schematic view of an exemplary operating environment including a social network server, a social network database, and a plurality of user systems operatively coupled to the server by a data network.

FIG. 2 is a schematic view of an exemplary social network website that may be hosted by the server of FIG. 1.

FIG. 3 is a flowchart illustrating a process for generating a challenge that may be implemented on the server or another computer of FIG. 1.

FIG. 4 is a diagrammatic view of a computer that may be used to implement one or more of the components or processes shown in FIGS. 1-3.

### DETAILED DESCRIPTION

Embodiments of the invention are directed to a social network website that promotes competition between users of the website. The website utilizes a computer system to organize in-person or virtual competitions between individual users or competing groups of users. Each user or group may have a multi-level classification (e.g., a three level classification such as category, subcategory, and group). The classifications may group users according to related interests. The website may include a web-based meeting management feature with a user interface accessible to multiple users. Each of the multiple users may use the user interface to challenge other users in at least one of multiple groups based on at least one category-related interest or geographic locale. A “call-out” may be initiated by a user (referred to as a “challenger”) who wants to challenge another user (referred to as a “defender”) to a competition by sending a “challenge” to the defender. The defender can then either accept or decline the challenge. The defender may also counter the challenge by issuing a “counterchallenge” having modified terms of engagement.

Exemplary categories for challenges may include art, fashion/beauty, four wheeled vehicles, two wheeled vehicles, combat, dance, debate, fitness, food/drink, games, music, photography, and sports, to name just a few. Each category may also have subcategories, e.g., “sports” may include basketball and football subcategories, “photography” may include digital and film photography subcategories, “combat” may include boxing and mixed martial arts subcategories, etc. Some subcategories may be further broken down into groups. For example, under “basketball” there could be one-on-one, five-on-five, three-point shot, etc. Additional categories, subcategories and groups may be added at any time, such as when needed to accommodate new forms of competition or when requested by users. The website may be publicly accessible, but may limit access to some pages (such as user profile pages and groups) unless the user has an account with appropriate access privileges.

A user may be required to have a user profile in order to join a category, subcategory, or group, or to be able to view other user profiles. Users may also only be allowed to vote or comment on a competition if they have joined a group with which the competition is associated. Competitions may be displayed as they occur, stored as a video clip that can be watched or shared at a later time, or by any other suitable means. Teams of users may create a profile (“team profile”) and join one or more groups. Each team member may be required to individually create a profile and join a group before they can join a team. Creating a profile and joining a category may enable users to follow or have access to other user profiles. Joining a subcategory may enable users to vote on competitions. Voting may be required for some competitions, and each user may have a single vote per competition video to choose a winner. Joining a group may enable users to have complete access to the group. This access may include the ability to challenge other users as well as comment on competitions associated with that specific group.

A challenger presents their initial terms and conditions of the proposed competition in the challenge. The terms and conditions may define the competition that tests the skill of both the challenger and the defender in a particular group. The defender has the option to accept the challenge, decline the challenge, or issue a counterchallenge. The counterchallenge may include acceptance conditioned on modified terms and conditions. The process of trading challenges and counterchallenges may be referred to as a “negotiation”. Once the terms and conditions are agreed upon by both parties (i.e., the negotiation is complete), the competition can be scheduled. The scheduling process may include agreeing to a time, date, and location for the challenge. The location may be a virtual location (e.g., a location in cyberspace) or a physical geographic location. The selection of time, date, and location may also occur as part of the challenge negotiation. Depending on the type of challenge or group rules, it may not be necessary for both participants to be in the same location, or for them to even perform their portion of the challenge at the same time. For example, a photography challenge could involve participants taking pictures in different geographic locations and posting the pictures at any point during a window of time allotted for the challenge.

Records may be maintained numerically as a 4 digit win/loss/draw/decline (W-L-D-D) record for each user or team and for each group in which the user or team competes. A record of accepted and declined challenges may also be maintained for each user or team and for each group in which the user or team competes. Each declined challenge may also be saved and made publicly available for viewing by other users. Win/loss/draw/declined records may collectively define a call-out record for the user.

Users may be assigned or otherwise associated with a skill level. In some embodiments, users may only be allowed to challenge other users having the same level of skill or a certain number of levels of skill (e.g., one level) above that of the challenger. Exemplary skill levels may include any suitable number of levels, e.g., Levels I-V. At certain levels (e.g., Levels II and III—described below), incentives may be offered (e.g., randomly or based on user metrics) to motivate users to increase their activity.

By way of example only, a Level I user may be a “Novice/Recreational Beginner”. Thus, Level I may provide an introductory level of competition suitable for a beginner or social league participant. Level I may welcome new users to Call-Out or those looking to just have fun. Users who are new to the activity or have little to no experience may be placed in Level I. Users in Level I may be about the social aspect as much as they are about the competition itself.

Level II may be an “Advanced Beginner” level having a relatively low level of competition involving users that are still new to the activity or that like to focus on the social aspect, but who are seeking a little more competition than is available at Level I. At Level II, rules are understood, users and teams have competed multiple times, tend to be more organized, and even compete with some strategy.

Level III may be a “Competent” or “Intermediate” level that produces a moderate level of competition. Level III may be made up of users and teams who have competition experience and are ready to challenge themselves competitively. Users and teams at this level may tend to be fundamentally strong, organized, and approach competitions strategically. Level III may produce high quality competitions, and users at this level may have a well-established Level II or Advanced Beginner Call-Out record.

Level IV may be a “Proficient” level that produces a high level of competition. Teams and users at this level may have competed for years, perform training on a regular basis, and enjoy the sheer pleasure of competition. Level IV users may be very skilled, and many of them may be focused on making their chosen area of competition a career by becoming a professional competitor. Level IV teams are very organized, users and teams have received trophies, medals, awards and/or certificates from competitions, and have a well-established intermediate level (Level III) Call-Out record. In some cases, users at this level may also have an established amateur record outside of Call-Out.

Level V may be an “Expert” or “Career” level in which users compete on a professional level. Users at this level may hold a professional win/loss record outside of Call-Out, and put in the time and effort necessary to become number one in their field.

Social media has changed our society by providing a new medium for sharing experiences that is globally accessible by nearly anyone at any time and any place. At the same time, competitions are an evolving cultural phenomenon not only for the participants and their physical activity, but also for other viewers to enjoy watching competitions in their favorite leisure activities. Embodiments of the present invention bring competitions into the social media arena, thereby making them accessible to persons anywhere at any time. This ability to compete and be seen competing provides users with a new tool for self-promotion, developing relationships with influencers, providing inspiration to other users, developing their talents, mental and physical conditioning, building and growing their brand, developing interests, finding others who share the same interests, and attracting the attention of coaches, trainers, sponsors and promotors. Embodiments of the invention provide a professional atmosphere for users of all ages that is free of bullies or shamers, and which promotes physical activity, in-person interaction, and personal growth.

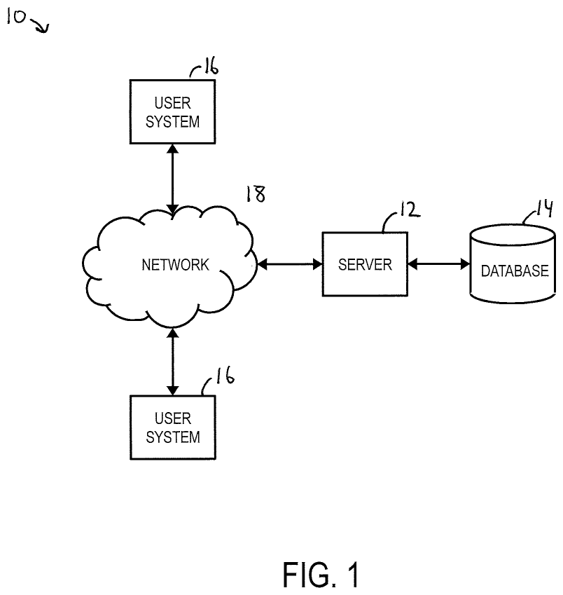

FIG. 1 depicts an exemplary operating environment 10 in accordance with an embodiment of the invention. The operating environment includes a social network server 12, a social network database 14, and a plurality of user systems 16 operatively coupled to the server 12 by a data network 18. The network 18 may include one or more private or public networks (e.g., the Internet) that enable the exchange of data between the server 12 and user systems 16. The server 12 may be configured to store information, retrieve information, and conduct transactions related to the operation of a social network as well as a website associated with the social network. Each user may access the website through an application (e.g., a web browser) running on their user system 16. The database 14 may comprise a stand-alone database system, a database system integrated with the server 12, or a database maintained by another system, and may store data relating to user profiles and other aspects of the social network.

The database 14 may be configured to collect and organize data used by the various systems and modules described herein. The database 14 may include data and supporting data structures that store and organize the data. In particular, the database 14 may be arranged with any database organization or structure including, but not limited to, a relational database, a hierarchical database, a network database, or combinations thereof. A database management system in the form of a computer software application executing as instructions on a computer may be used to access the information or data stored in records of the database 14 in response to a query, which may be dynamically determined and executed by an operating system, application, or module of the computer.

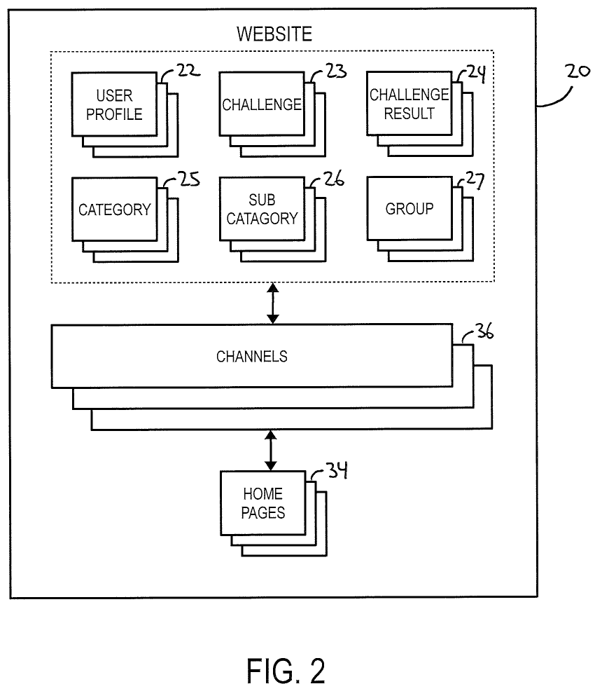

FIG. 2 depicts an exemplary social network website 20 that may be hosted by the server 12. The server 12 may maintain a plurality of objects 22-27 that users can interact with on the website 20. Exemplary objects 22-27 may include, but are not limited to, user profiles 22, challenges 23, challenge results 24, categories 25, subcategories 26, and groups 27. An object 22-27 may be maintained by the website 20 for each instance of the thing associated with the object. For example, a user profile 22 may be stored by the website 20 for each user who joins the website 20, a challenge 23 may be stored for each challenge issued by the website users, etc.

The website 20 may further include a plurality of webpages 34, e.g., user home pages, guest webpages, sign up webpages, challenge location or host webpages, or other webpages that enable users/guests to interact with the website 20. Users logged into their home page may interact with the objects 22-27 using one or more channels. Each channel 36 may provide a mechanism for users to interact with the objects 22-27, such as a personal messaging function, a timeline posting function for adding content to a personal or group newsfeed or home page, or any other mechanism suitable for interacting with the objects 22-27. The channels 36 may enable users to upload various media (e.g., text, audio, and video) to one or more target objects 22-27. The channels 36 may thereby enable users to perform actions such as modifying a user profile, issuing a challenge, responding to a challenge, etc.

Each action by a user interacting with the website 20 may be associated with one or more of the objects 22-27. The types of actions that can be taken by a user may depend on the thing represented by the object or objects 22-27 involved. By way of example, one user issuing a challenge to another user may result in generation of a challenge 23. The challenge 23 may be stored as one or more database records in the database 14. These database records may in turn be associated with the user profiles of the challenger and the defender in the database 14.

Other actions may include one user requesting a connection with another user (i.e., “friending”), sending a message to the other user, viewing a user profile, or responding to a challenge, for example. A group 27 may be defined for and associated with a set of users having a common characteristic in their user profiles 22 or that have requested to join the group 27. Other user actions with respect to a group 27 may include viewing group content, such as images posted by group members, challenges issued/accepted, win/loss record, etc.

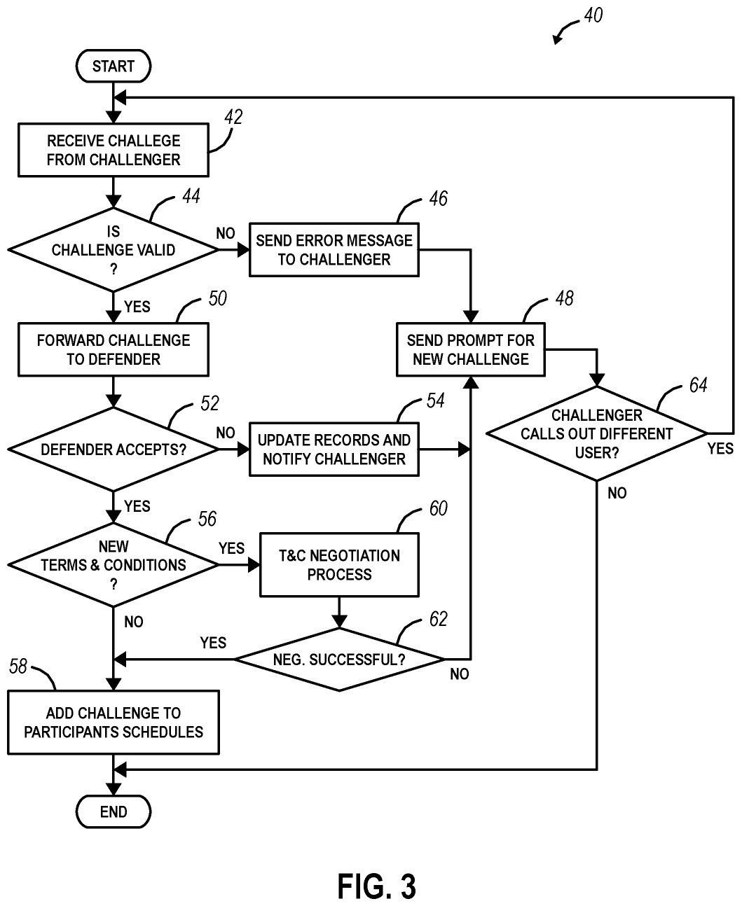

FIG. 3 depicts a flowchart illustrating a challenge generation process 40 that may be implemented by the server 12 or any other suitable computer of operating environment 10. In block 42, the process 40 receives a challenge from a challenger. As described above, the challenge defines the terms and conditions of the proposed activity as well as the identity of a defender. In response to receiving the challenge, the process 40 may proceed to block 44 and validate the challenge.

Validating the challenge may include, for example, determining whether the challenge meets all necessary requirements of a valid challenge. These requirements may include, for example, that the age group and gender match, that the skill levels of the challenger and defender be matched, that the defender accepts challenges from the challenger (e.g., the challenger is not on a blocked list of the defender), that the challenge is fully defined in terms of what the task or activity is and how the winner will be determined, and that the challenge meets any other rules required by the group or system administrator (e.g., the task or activity does not include prohibited activities).

If the challenge is not valid (“NO” branch of decision block 44), the process 40 may proceed to block 46, send an error message to the challenger informing them of the deficiencies in the challenge, then proceed to block 48 and send a prompt to the challenger to issue a new challenge. If the challenge is valid (“YES” branch of decision block 44), the process 40 may proceed to block 50 and forward the challenge to the defender.

In block 52, the process 40 may determine whether the defender has accepted or declined the challenge. This determination may be made based on a response received from the defender, based on an amount of time passing without receiving a response from the defender (e.g., the passing of a deadline for responding), or any other suitable metric. For example, if no response is received within 48 hours of the defender either receiving or reading the challenge, the challenge may be considered as declined.

If the challenge is declined (“NO” branch of decision block 52), the process 40 may proceed to block 54, update the records of the respective user profiles, and notify the challenger. The process 40 may then proceed to block 48 and send a prompt to the challenger to issue a new challenge. If the challenge is accepted (“YES” branch of decision block 52), the process 40 may proceed to block 56 and determine if the response from the defender includes any proposed modifications to the terms and conditions of the challenge.

If the response does not include any changes (i.e., the challenge was accepted as is), the process 40 may proceed to block 58 and add the challenge to the challenger's and defender's respective schedules. In cases where the challenge events are to occur online, the process 40 may also generate a new webpage or identify an existing webpage that will host the challenge events, and forward links to the webpage to each of the participants. Participants may include the challenger, the defender, other users subscribed to the group, or any other users who may wish to witness the competition. If the response does include proposed changes to the terms and conditions of the challenge (“YES” branch of decision block 56), the process 40 may proceed to block 60 and initiate/manage a terms and conditions negotiation process between the challenger and the defender. If the negotiation is not successful (“NO” branch of decision block 62), the process 40 may proceed to block 48 and send a prompt to the challenger to issue a new challenge as described above. If the negotiation is successful (“YES” branch of decision block 62), the process 40 may proceed to block 58 and add the negotiated challenge to the challenger's and defender's respective schedules as described above.

In response to receiving the prompt for the new challenge sent in block 48, the challenger may decide to call out another user, or may decide not to call out another user. If the challenger does call out another user (“YES” branch of decision block 64), the process 40 may proceed to block 42, receive a new challenge from the challenger, and process that challenge as described above. If the challenger does not respond to the prompt, or otherwise declines not to call out another user (“NO” branch of decision block 64), the process 40 may terminate.

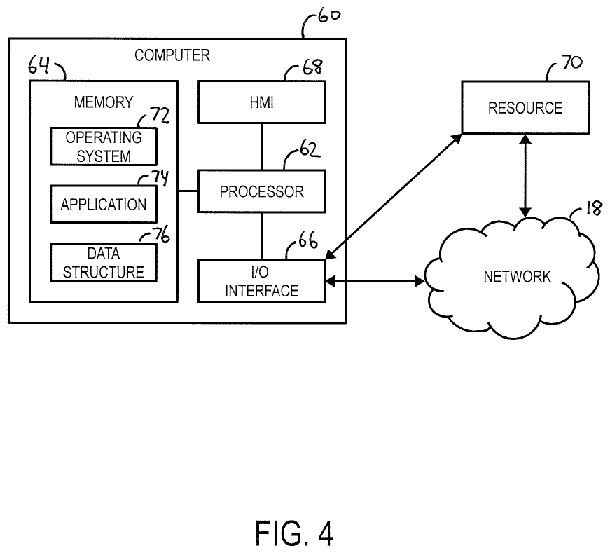

Referring now to FIG. 4, embodiments of the invention described above, or portions thereof, may be implemented using one or more computer devices or systems, such as exemplary computer 60. The computer 60 may include a processor 62, a memory 64, an input/output (I/O) interface 66, and a Human Machine Interface (HMI) 68. The computer 60 may also be operatively coupled to one or more external resources 70 via the network 18 or I/O interface 66. External resources may include, but are not limited to, servers, databases, mass storage devices, peripheral devices, cloud-based network services, or any other resource that may be used by the computer 60.

The processor 62 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions stored in memory 64. Memory 64 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 62 may operate under the control of an operating system 72 that resides in memory 64. The operating system 72 may manage computer resources so that computer program code embodied as one or more computer software applications, such as an application 74 residing in memory 64, may have instructions executed by the processor 62. One or more data structures 76 may also reside in memory 64, and may be used by the processor 62, operating system 72, or application 74 to store or manipulate data.

The I/O interface 66 may provide a machine interface that operatively couples the processor 62 to other devices and systems, such as the external resource 70 or the network 18. The application 74 may thereby work cooperatively with the external resource 70 or network 18 by communicating via the I/O interface 66 to provide the various features, functions, applications, processes, or modules comprising embodiments of the invention. The application 74 may also have program code that is executed by one or more external resources 70, or otherwise rely on functions or signals provided by other system or network components external to the computer 60. Indeed, given the nearly endless hardware and software configurations possible, persons having ordinary skill in the art will understand that embodiments of the invention may include applications that are located externally to the computer 60, distributed among multiple computers or other external resources 70, or provided by computing resources (hardware and software) that are provided as a service over the network 18, such as a cloud computing service.

The HMI 68 may be operatively coupled to the processor 62 of computer 60 to enable a user to interact directly with the computer 60. The HMI 68 may include video or alphanumeric displays, a touch screen, a speaker, and any other suitable audio and visual indicators capable of providing data to the user. The HMI 68 may also include input devices and controls such as an alphanumeric keyboard, a pointing device, keypads, pushbuttons, control knobs, microphones, etc., capable of accepting commands or input from the user and transmitting the entered input to the processor 62.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the flow-charts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the flow-charts, sequence diagrams, or block diagrams.

In certain alternative embodiments, the functions, acts, or operations specified in the flow-charts, sequence diagrams, or block diagrams may be re-ordered, processed serially, or processed concurrently consistent with embodiments of the invention. Moreover, any of the flow-charts, sequence diagrams, or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include both the singular and plural forms, and the term “or” is intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method of processing requests from a user system associated with a user profile in a database of a social network website, comprising:
receiving a challenge that identifies a first user, a second user, and a task or activity which the first user is challenging the second user to perform;
forwarding the challenge to the second user; and
in response to receiving an acceptance of the challenge from the second user, publishing the challenge on the social network website.

2. The method of claim 1, further comprising:
searching the database for the user profile of the second user;
validating the challenge based at least in part on information in the user profile of the second user; and
only forwarding the challenge to the second user if the challenge is valid.

3. The method of claim 2, wherein validating the challenge includes comparing skill levels of the first user and the second user, and only validating the challenge if the skill levels match.

4. The method of claim 1, wherein:
publishing the challenge includes posting information regarding the challenge on a home page of one or more users having profiles in the database,
the challenge further identifies at least one of a time, a date, and a location for performing the task or activity, and
the location is one of a geographic location or a virtual location.

5. The method of claim 4, wherein the location is the virtual location, and further comprising:
defining a webpage on the social network website which provides the virtual location for performing the task or activity; and
transmitting a link to the webpage to the user system of each of the first user and the second user.

6. The method of claim 1, further comprising:
posting the challenge to a webpage of the social network website; and
in response to a web browser visiting the webpage, displaying the challenge on a user interface of the web browser.

7. The method of claim 1, wherein each user profile defines at least one of a category, a subcategory, and a group associated with the user profile.

8. The method of claim 1, wherein each user profile includes a call-out record, and further comprising:
in response to the second user accepting the challenge, adding the challenge to the call-out record of the user profile of each of the first user and the second user.

9. The method of claim 8, further comprising:
in response to the challenge being completed, posting a result of the challenge on the user profile of each of the first user and the second user.

10. The method of claim 1, wherein the first user and the second user are part of a plurality of users, and further comprising:
receiving one or more votes from the plurality of users regarding each voting user's selection of a winner of the challenge; and
selecting the winner of the challenge based at least in part on the one or more votes received.

11. The method of claim 10, wherein a user must be a member of a group with which the challenge is associated in order to vote on the winner of the challenge.

12. An apparatus for processing requests from a user system associated with a user profile in a database of a social network website, comprising:
one or more processors; and
a memory coupled to the one or more processors and including program code that, when executed by the one or more processors, causes the apparatus to:
receive a challenge that identifies a first user, a second user, and a task or activity which the first user is challenging the second user to perform;
forward the challenge to the second user; and
in response to receiving an acceptance of the challenge from the second user, publish the challenge on the social network website.

13. The apparatus of claim 12, wherein the program code further causes the apparatus to:
search the database for the user profile of the second user;
validate the challenge based at least in part on information in the user profile of the second user; and
only forward the challenge to the second user if the challenge is valid.

14. The apparatus of claim 12, wherein the challenge further identifies a virtual location for performing the task or activity, and the program code further causes the apparatus to:
define a webpage on the social network website which provides the virtual location for performing the task or activity; and
transmit a link to the webpage to the user system of each of the first user and the second user.

15. The apparatus of claim 12, wherein the program code further causes the apparatus to:
post the challenge to a webpage of the social network website; and
in response to a web browser visiting the webpage, display the challenge on a user interface of the web browser.

16. The apparatus of claim 12, wherein each user profile includes a call-out record, and the program code further causes the apparatus to:
in response to the second user accepting the challenge, add the challenge to the call out record of the user profile of each of the first user and the second user, and
in response to the challenge being completed, post a result of the challenge on the user profile of each of the first user and the second user.

17. The apparatus of claim 12, wherein the first user and the second user are part of a plurality of users, and the program code further causes the apparatus to:
receive one or more votes from the plurality of users regarding each voting user's selection of a winner of the challenge; and
select the winner of the challenge based at least in part on the one or more votes received.

18. The apparatus of claim 17, wherein a user must be a member of a group with which the challenge is associated in order to vote on the winner of the challenge.

19. The apparatus of claim 12, wherein the first user and the second user are part of a plurality of users, and the program code further causes the apparatus to:
maintain a record for each user including one or more of challenges won, challenges lost, challenges that were a draw, and challenges declined.

20. A computer program product for processing requests from a user system associated with a user profile in a database of a social network website, comprising:
a non-transitory computer-readable storage medium; and
program code stored on the non-transitory computer-readable storage medium that, when executed by one or more processors, causes the one or more processors to:
receive a challenge that identifies a first user, a second user, and a task or activity which the first user is challenging the second user to perform;
forward the challenge to the second user; and
in response to receiving an acceptance of the challenge from the second user, publish the challenge on the social network website.
